(19) United States
(12) Patent Application Publication
(10) Pub. No.: US 2022/0416615 A1
(43) Pub. Date: Dec. 29, 2022

(54) BUS BAR AND MOTOR

(71) Applicant: NIDEC CORPORATION, Kyoto (JP)

(72) Inventors: Yuta NINOMIYA, Kyoto (JP); Yuya SAITO, Kyoto (JP); Takashi SEGUCHI, Kyoto (JP); Hideo FUJIWARA, Kyoto (JP)

(21) Appl. No.: 17/620,739

(22) PCT Filed: May 28, 2020
(86) PCT No.: PCT/JP2020/021083

§ 371 Date: Dec. 20, 2021

(30) Foreign Application Priority Data
Jun. 28, 2019 (JP) 2019-120776

(51) Int. Cl. H02K 5/22; H02K 3/50

(52) U.S. Cl. CPC H02K 5/225; H02K 3/50; H02K 2203/09

(57) ABSTRACT

The bus bar includes the motor connection member electrically connected to the coil provided in the motor, and the terminal member that is formed of a separate member from the motor connection member and is electrically connected to the external terminal. The motor connection member includes the body portion electrically connected to the coil, and the bent portion that is bent at the first end portion of the body portion in a direction intersecting with the body portion. The terminal member is connected to the bent portion.

### CROSS-REFERENCE TO RELATED APPLICATIONS

This is the U.S. national stage of application No. PCT/JP2020/021083, filed on May 28, 2020, and priority under 35 U.S.C. § 119(a) and 35 U.S.C. § 365(b) is claimed from Japanese Patent Application No. 2019-120776, filed on Jun. 28, 2019.

### FIELD OF THE INVENTION

The present invention relates to a bus bar and a motor.

### BACKGROUND

There is known a bus bar that relays electrical connection between a coil of a motor and an external terminal.

For example, a conventional bus ring (bus bar) has a ring body and a plate-like piece. The ring body has a plate-like shape included in a plane orthogonal to an axial direction of the ring body. The plate-like piece is formed by being bent from one circumferential end of the ring body in a direction along the axial direction of the ring body. The ring body includes a terminal part that extends radially outward of the ring body and is to be connected to a coil terminal of the motor. The plate-like piece is connected at its leading end portion to a control circuit as an external terminal using a connection terminal of a coupler.

To reduce manufacturing cost of the bus bar, members constituting the bus bar are preferably shared by being standardized in thickness, material, and the like. Unfortunately, for example, an external terminal such as a control circuit or an external power supply is supplied from a user in many cases. In this case, the user may designate thickness, material, and the like of a connection portion of the bus bar to the external terminal.

When the connection portion to the external terminal is changed in thickness, material, and the like according to a specification, the members of the bus bar cannot be shared. As a result, reduction of the manufacturing cost of the bus bar is hindered.

### SUMMARY

A bus bar according to an exemplary embodiment of the invention of the present application is used for a motor, the bus bar including: a motor connection member that is electrically connected to a coil provided in the motor; and a terminal member that is formed of a separate member from the motor connection member and is electrically connected to an external terminal, the motor connection member including a body portion electrically connected to the coil, and a bent portion bent at a first end portion of the body portion in a direction intersecting the body portion, and the terminal member being connected to the bent portion.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a sectional view illustrating a structure of a motor according to an embodiment of the present invention;

FIG. 2 is a diagram conceptually illustrating a connection structure of a coil according to an embodiment of the present invention;

FIG. 3 is a diagram conceptually illustrating a circuit structure of a coil according to an embodiment of the present invention;

FIG. 4 is a perspective view illustrating a bus bar and a bus bar holder according to an embodiment of the present invention;

FIG. 5 is a perspective view illustrating a bus bar according to an embodiment of the present invention;

FIG. 6 is a perspective view illustrating a motor connection member and a terminal member according to an embodiment of the present invention;

FIG. 7 is a perspective view illustrating a neutral point member according to an embodiment of the present invention;

FIG. 8 is a diagram schematically illustrating a method for welding a terminal member and a motor connection member according to an embodiment of the present invention; and

FIG. 9 is a diagram according to a modification of an embodiment of the present invention, corresponding to FIG. 6.

### DETAILED DESCRIPTION

Hereinafter, an embodiment of the present invention will be described in detail with reference to the drawings. The following description of a preferable embodiment is merely exemplary in nature and is not intended to limit the present invention, its application product, or its use.

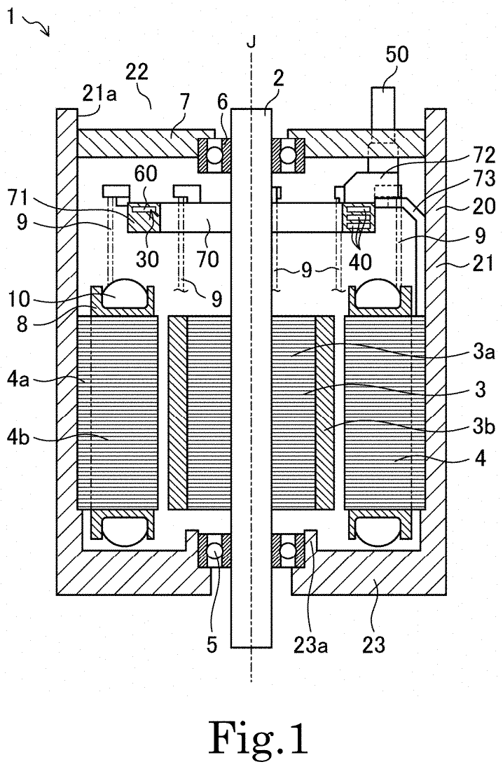

Hereinafter, a central axis of a motor 1 is indicated as J, and a direction parallel to the central axis J is referred to as an “axial direction”. A radial direction centered on the central axis J is referred to as a “radial direction”, and a direction around the central axis J is referred to as a “circumferential direction”. FIG. 1 is a sectional view illustrating a structure of a motor 1 according to the embodiment of the present invention, and an upper side in FIG. 1 is referred to as one axial side, and a lower side therein is referred to as the other axial side. A combination of a plurality of motor connection members, a plurality of terminal members, and a neutral point member, which will be described later, is referred to as a “bus bar” as a whole.

As illustrated in FIG. 1, the motor 1 includes a shaft 2. The shaft 2 is rotatably supported about the axial direction. The motor 1 includes a rotor 3 and a stator 4. The rotor 3 is fixed to the shaft 2 and rotates integrally with the shaft 2. The rotor 3 includes a rotor core 3a and a rotor magnet 3b. The rotor core 3a is formed by stacking metal plates such as electromagnetic steel plates, and is fitted on the shaft 2. The rotor magnet 3b is fixed to an outer peripheral portion of the rotor core 3a.

The stator 4 is disposed radially outside the rotor 3. The shaft 2, the rotor 3, and the stator 4 are accommodated in a housing 20. The housing 20 has a bottom portion 23 and a wall portion 21 extending axially from the bottom portion 23. The housing 20 has, for example, a bottomed substantially cylindrical shape. The housing 20 has an opening 22 on the one axial side. The opening 22 is covered with a bracket (not illustrated). The stator 4 is fitted to an inner wall surface 21a of the wall portion 21 of the housing 20.

The motor 1 includes a first bearing 5 and a second bearing 6 that rotatably support the shaft 2. Specifically, the motor 1 includes the first bearing 5 located on the other axial side with respect to the stator 4, and a second bearing 6 located on the one axial side with respect to the stator 4. The first bearing 5 is held by the housing 20. Specifically, the first bearing 5 is held by a holding portion 23a provided on the bottom portion 23. The second bearing 6 is held by a bearing holder 7 fixed to the housing 20 on the one axial side with respect to the stator 4. The bearing holder 7 is fitted to an inner wall surface 21a of the housing 20.

The stator 4 is formed by stacking metal plates such as electromagnetic steel plates. The stator 4 includes a core back 4a extending in the circumferential direction, and a plurality of teeth 4b extending radially inward from an inner peripheral surface of the core back 4a and arranged in the circumferential direction over the entire circumference of stator 4. In the present embodiment, the stator 4 includes twelve teeth 4b. The stator 4 is provided with an insulator 8. The insulator 8 is made of insulative resin, and configured to cover both axial end surfaces and both circumferential end surfaces of each of the teeth 4b. Each of the teeth 4b is wound with conductive wire 9 with the insulator 8 interposed therebetween to form a coil 10. The motor 1 includes twelve coils 10 arranged in the circumferential direction over the entire circumference of the motor 1.

The motor 1 includes a bus bar holder 70 and a bus bar 30 accommodated in the bus bar holder 70 on the one axial side with respect to the stator 4 and on the other axial side with respect to the bearing holder 7. Details of the bus bar 30 and the bus bar holder 70 will be described later.

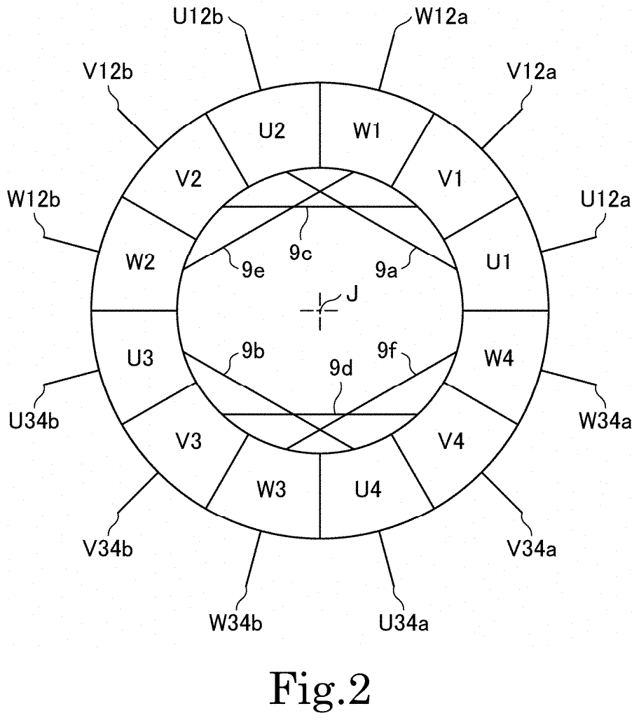

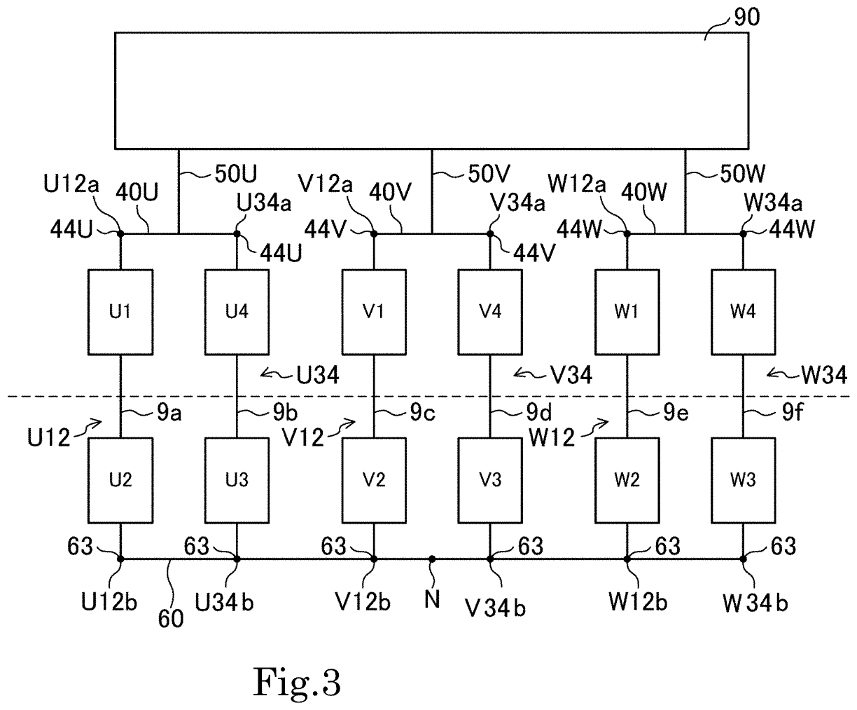

As conceptually illustrated in FIGS. 2 and 3, the motor 1 of the present embodiment is a three-phase induction motor (three-phase motor) having a U phase, a V phase, and a W phase. As illustrated in FIG. 3, the motor 1 includes four U-phase coils U1 to U4, four V-phase coils V1 to V4, and four W-phase coils W1 to W4. As illustrated in FIG. 2, these phase coils are arranged at equal intervals in the circumferential direction in the order of coils U1, V1, W1, U2, V2, W2, U3, V3, W3, U4, V4, and W4.

As illustrated in FIG. 2, six coil pairs U12, U34, V12, V34, W12, and W34 include pairs of coils U1 and U2, U3 and U4, V1 and V2, V3 and V4, W1 and W2, and W3 and W4, respectively, and are formed of one continuous conductive wires 9a to 9f, respectively. Each of the coil pairs includes two coils that are connected in series. For example, the coil pair U12 includes the pair of coils U1 and U2 that is formed of the one continuous conductive wire 9a and that is connected in series.

As illustrated in FIG. 3, a first end portion U12a of the coil pair U12 and a first end portion U34a of the coil pair U34 are both electrically connected to a motor connection member 40U of the bus bar 30 described later. A first end portion V12a of the coil pair V12 and a first end portion V34a of the coil pair V34 are both electrically connected to a motor connection member 40V of the bus bar 30. A first end portion W12a of the coil pair W12 and a first end portion W34a of the coil pair W34 are both electrically connected to a motor connection member 40W of the bus bar 30. As a result, the coil pairs U12 and U34, the coil pairs V12 and V34, and the coil pairs W12 and W34, are each connected in parallel. Although details will be described later, as illustrated in FIG. 3, the motor connection members 40U, 40V, and 40W are electrically connected to an external terminal 90 such as a control circuit or an external power supply using terminal members 50U, 50V, and 50W of the bus bar 30, respectively.

As illustrated in FIG. 3, the coil pairs U12, U34, V12, V34, W12, and W34 respectively include second end portions U12b, U34b, V12b, V34b, W12b, and W34b that are electrically connected to a neutral point member 60 of the bus bar 30 to be described later, and that form a Y connection at a neutral point N.

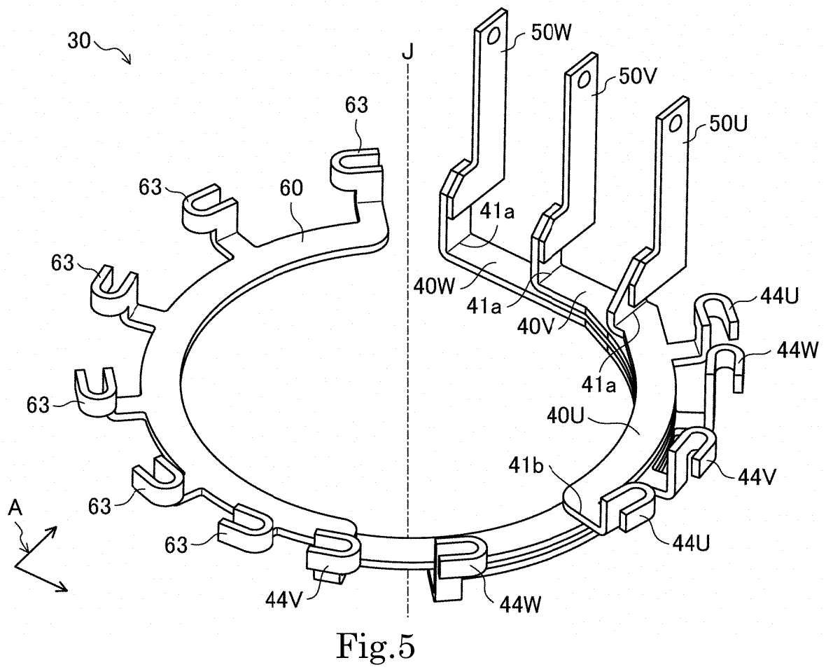

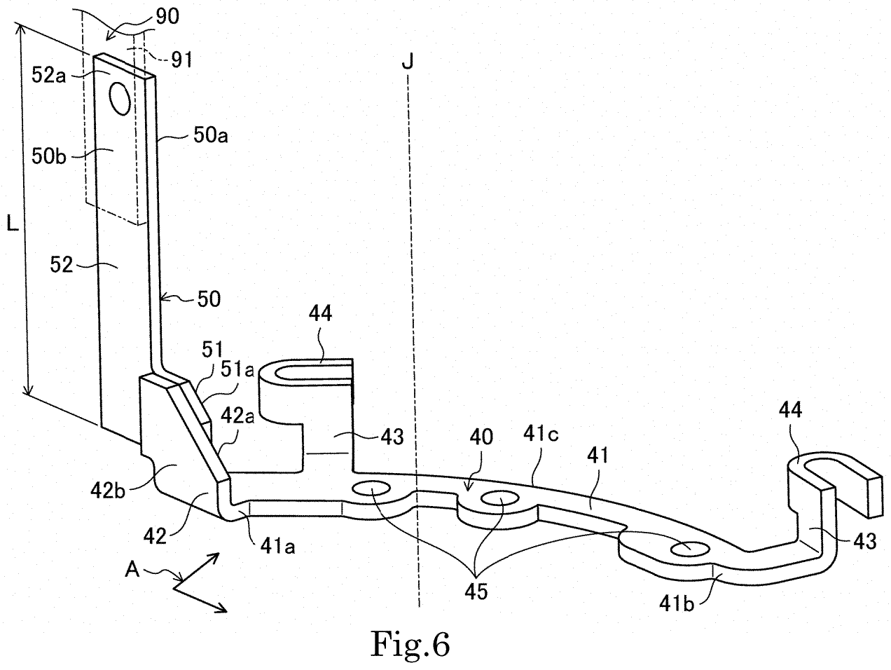

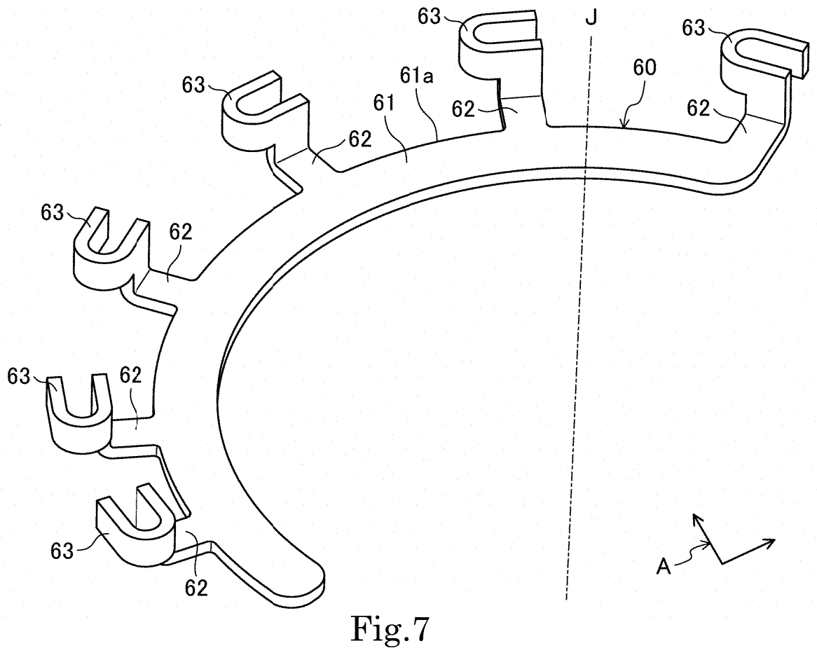

Details of the bus bar 30 used for the motor 1 will be described with reference to FIGS. 5, 6, and 7. Here, FIG. 5 is a perspective view illustrating the bus bar 30. FIG. 6 is a perspective view illustrating a motor connection member 40 and a terminal member 50. FIG. 7 is a perspective view illustrating the neutral point member 60.

As illustrated in FIG. 5, the bus bar 30 includes a plurality of motor connection members 40, a plurality of terminal members 50, and the neutral point member 60. The plurality of motor connection members 40 include the motor connection member 40U for the U-phase, the motor connection member 40V for the V-phase, and the motor connection member 40W for the W-phase. The plurality of terminal members 50 include a terminal member 50U for the U-phase, a terminal member 50V for the V-phase, and a terminal member 50W for W-phase, corresponding to the motor connection members 40U, 40V, and 40W, respectively.

As illustrated in FIG. 6, each motor connection member 40 is formed of one plate-like member made of a conductive metal material such as copper. Each motor connection member 40 is formed by bending the one plate-like member, and includes a body portion 41 and a bent portion 42. The body portion 41 extends in an arc shape along one plane.

Such structure allows the body portion 41 to extend in an arc shape, so that each motor connection member 40 can be disposed along the circumferential direction of the motor 1. Then, the coils 10 are arranged along the circumferential direction of the motor 1. That is, the motor connection members 40 can be disposed along a direction in which the coils 10 are arranged, so that the conductive wire 9 extending from each coil 10 can be connected to each motor connection member 40 while being reduced in extension as much as possible.

The bent portion 42 is bent at a first end portion 41a of the body portion 41 in a direction intersecting with an extending direction of the body portion 41, specifically, in a direction orthogonal to the extending direction. Each motor connection member 40 is disposed such that a central axis of the arc shape of the body portion 41 is concentric with the central axis J of the motor 1. That is, the body portion 41 extends in the circumferential direction along a plane A orthogonal to the axial direction of the motor 1. The bent portion 42 is bent in the axial direction of the motor 1. In the present embodiment, the body portion 41 of each motor connection member 40 has a thickness direction coinciding with the axial direction of the motor 1. That is, each motor connection member 40 is disposed in so-called horizontal placement (hereinafter, referred to as horizontally placed).

According to such structure, when the motor connection member 40 formed of the plate-like member is horizontally placed, the body portion 41 extends along the plane A orthogonal to the axial direction, and the bent portion 42 is bent in the axial direction instead of the radial direction. This enables preventing the bus bar 30 from enlarging in the radial direction.

Each motor connection member 40 includes two coil connection terminals 44 that are each provided radially outside an outer peripheral portion 41c of the body portion 41 with a connection portion 43 in a substantially L-shape. The two coil connection terminals 44 are arranged at an interval in the circumferential direction.

The two coil connection terminals 44 provided in the body portion 41 of each motor connection member 40 are electrically connected to the coil 10 provided in the motor 1. Specifically, as illustrated in FIG. 3, the motor connection member 40U includes coil connection terminals 44U and 44U that are electrically connected to the first end portions U12a and U34a of the coil pairs U12 and U34, respectively. The motor connection member 40V includes coil connection terminals 44V and 44V that are electrically connected to the first end portions V12a and V34a of the coil pairs V12 and V34, respectively. The motor connection member 40W includes coil connection terminals 44W and 44W that are electrically connected to the first end portions W12a and W34a of the coil pairs W12 and W34, respectively.

The body portion 41 of each motor connection member 40 is provided with a plurality of holes 45. These holes 45 are used for inserting an instrument (not illustrated) for positioning each motor connection member 40 in the bus bar holder 70.

Each terminal member 50 is formed of a member that is separate from each motor connection member 40, and that is in a plate-like shape made of a conductive metal material such as copper. Each terminal member 50 includes a first extending portion 51 and a second extending portion 52 intersecting with each other. In the present embodiment, each terminal member 50 has a substantially L shape in which the first extending portion 51 and the second extending portion 52 are orthogonal to each other.

The first extending portion 51 includes an end portion 51a that is connected to a first surface 42a of the bent portion 42 facing the body portion 41 by resistance welding, for example. The first extending portion 51 extends radially outward from the end portion 51a and is connected to the second extending portion 52. The second extending portion 52 extends in the axial direction. The second extending portion 52 includes an end portion 52a that is connected to a connection terminal 91 of the external terminal 90. The connection terminal 91 is connected to a surface 50b of the end portion 52a of the second extending portion 52, the surface 50b being opposite to a surface 50a facing the body portion 41. Thus, respective terminal members 50 are electrically connected to the motor connection members 40 and external terminals 90. The term, a “surface facing the body portion”, refers to a surface located on a side close to the body portion 41 with respect to a direction in which the bent portion 42 is bent (direction in which the bent portion 42 extends), and does not necessarily face the body portion 41. The term, a “surface opposite to the surface facing the body portion” refers to a back surface with respect to the “surface facing the body portion”.

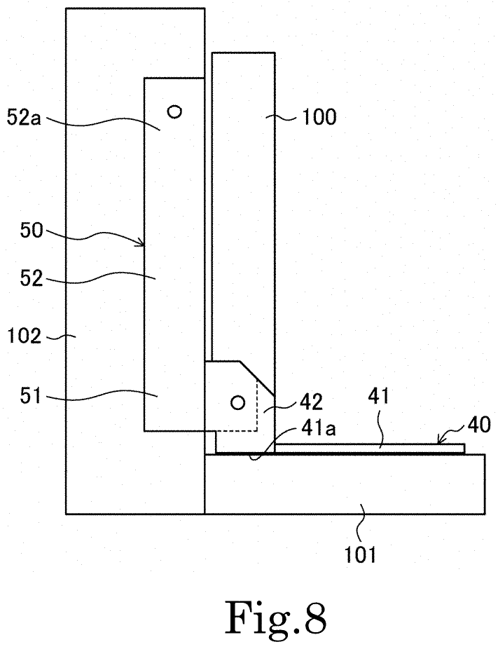

The terminal member 50 and the motor connection member 40 are welded as follows, for example. As illustrated in FIG. 8, the body portion 41 of the motor connection member 40 is held by a receiving jig 101, and the second extending portion 52 of the terminal member 50 is held by a receiving jig 102. Here, a welding jig 100 is pressed against the first end portion 41a of the body portion 41 from the thickness direction. As a result, the motor connection member 40 does not move with respect to the receiving jig 101. That is, a position of the first surface 42a of the bent portion 42 in the motor connection member 40 is fixed. The receiving jig 101 extends along the extending direction of the body portion 41. The receiving jig 102 extends along the extending direction of the second extending portion 52. The welding jig 100 extends in the thickness direction of the body portion 41. That is, the welding jig 100 extends parallel to the extending direction of the receiving jig 102. In this state, the end portion 52a of the second extending portion 52 of the terminal member 50 is connected to the first surface 42a of the bent portion 42 of the motor connection member 40 by resistance welding, for example.

According to such structure, as illustrated in FIG. 8, the second extending portion 52 is positioned while being shifted radially outward from the bent portion 42 (first end portion 41a) of the motor connection member 40. That is, the welding jig 100 pressed against the first end portion 41a of the body portion 41 does not interfere with the second extending portion 52. Thus, even when the welding jig 100 is inserted parallel to the receiving jig 102, the end portion 51a of the first extending portion 51 and the first surface 42a of the bent portion 42 can be welded by preventing the welding jig 100 from interfering with the second extending portion 52.

As illustrated in FIG. 7, the neutral point member 60 is formed of a plate-like member made of a conductive metal material such as copper. The neutral point member 60 includes a body portion 61 extending in an arc shape. As with each motor connection member 40, the neutral point member 60 is disposed such that a central axis of the arc shape of the body portion 61 is concentric with the central axis J of the motor 1. The neutral point member 60 extends in the circumferential direction along the plane A orthogonal to the axial direction of the motor 1.

The neutral point member 60 includes six coil connection terminals 63 that are each provided on radially outside an outer peripheral portion 61a of the body portion 61 with a connection portion 62 in a substantially L-shape. The six coil connection terminals 63 are arranged at intervals in the circumferential direction.

The neutral point member 60 is electrically connected to each of the coils 10 provided in the motor 1 to constitute a neutral point. Specifically, as illustrated in FIG. 3, the six coil connection terminals 63 of the neutral point member 60 are connected to the corresponding second end portions U12b, U34b, V12b, V34b, W12b, and W34b of the corresponding coil pairs U12, U34, V12, V34, W12, and W34. As a result, the neutral point member 60 connects the U-phase, V-phase, and W-phase coils to form a Y connection as the neutral point N.

Such structure enables the neutral point N to be formed only by connecting the U-phase, V-phase, and W-phase coils to the neutral point member 60, and thus the structure is simple.

As illustrated in FIG. 5, the motor connection members 40U, 40V, and 40W are disposed overlapping each other in the thickness direction (axial direction) of each body portion 41 in a plate-like shape. Specifically, the motor connection member 40W, the motor connection member 40V, and the motor connection member 40U are disposed overlapping each other in this order from the other axial side to the one axial side, and have portions partially overlapping each other in the circumferential direction.

Such structure enables preventing the bus bar 30 from enlarging as compared with when the motor connection members 40 are arranged in a width direction of the body portion 41. In particular, when the thickness direction of the body portion 41 coincides with the axial direction of the motor 1, the motor connection members 40 can be disposed overlapping each other in the axial direction being the thickness direction of the body portion 41. This enables preventing the bus bar 30 from enlarging in the radial direction as compared with when the motor connection members 40 are arranged in the radial direction being the width direction of the body portion 41. This also enables the coil connection terminals 44 of the motor connection members 40 to be aligned with each other in the radial direction.

The neutral point member 60 is disposed overlapping the motor connection member 40V from the one axial side. The neutral point member 60 includes a portion partially overlapping the motor connection member 40V in the circumferential direction.

The motor connection members 40U, 40V, and 40W are each disposed having the body portion 41 extending in the same direction. Specifically, as illustrated in FIG. 5, the body portion 41 of each of the motor connection members 40U, 40V, and 40W extends clockwise from the first end portion 41a to a second end portion 41b as viewed from the one axial side.

Such structure enables the terminal members 50U, 50V, and 50W provided close to the first end portion 41a to be collectively disposed at one place. This enables welding work between external terminals 90 and the respective terminal members 50 to be collectively performed at the one place, so that the welding work is facilitated.

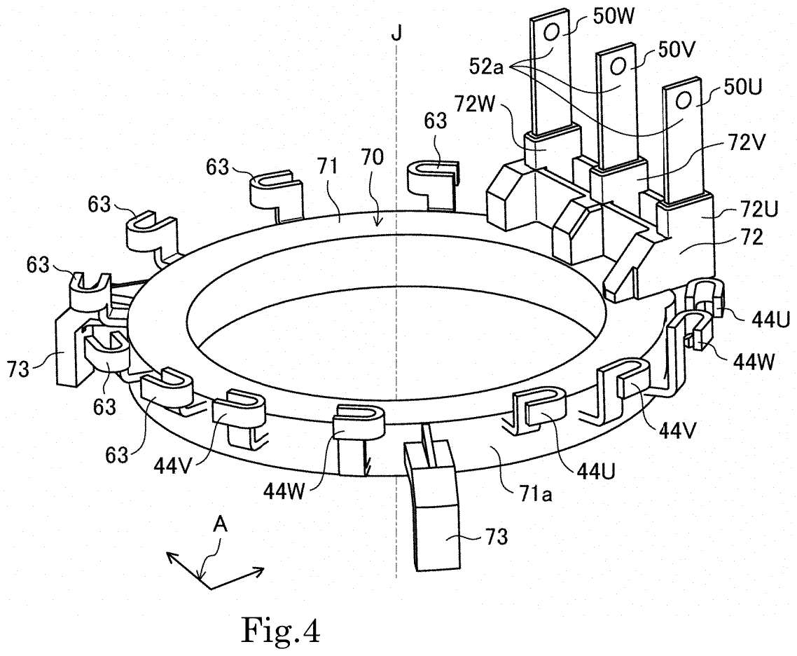

As illustrated in FIG. 4, the bus bar 30 is accommodated in the bus bar holder 70. The bus bar holder 70 is made of an insulating material such as resin. In the present embodiment, the bus bar holder 70 is an insert-molded article. The bus bar holder 70 is molded together with the bus bar 30. The bus bar holder 70 includes a body portion 71 in a ring-like shape, a connecting portion 72, and three leg portions 73. The bus bar holder 70 is disposed such that a central axis of the body portion 71 is concentric with the central axis J of the motor 1. The body portion 71 is configured to cover each motor connection member 40 of the bus bar 30. The coil connection terminals 44 and 63 of the motor connection members 40U, 40V, and 40W and the neutral point member 60 are exposed radially outward from an outer peripheral portion 71a of the body portion 71.

The connecting portion 72 extends toward the one axial side from the body portion 71 and holds the three terminal members 50U, 50V, and 50W. Connecting portions 72U, 72V, and 72W are configured to cover rising portions of the terminal members 50U, 50V, and 50W, respectively. That is, the connecting portion 72 is configured to cover at least a connection portion between the terminal member 50 and the motor connection member 40. The connecting portions 72U, 72V, and 72W are connected in the circumferential direction. Providing the connecting portion 72 enables reducing positional deviation of the terminal member 50. Although in the present embodiment, the connecting portion 72 is provided at one place, it may be provided at two or more places depending on structure of the bus bar 30.

The three leg portions 73 are disposed at substantially equal intervals in the circumferential direction of the body portion 71. Each leg portion 73 protrudes radially outward from the coil connection terminals 44 and 63 and is supported on an outer peripheral side of the stator 4 as illustrated in FIG. 1. Specifically, the leg portion 73 includes a leading end portion that is fitted into a groove portion (not illustrated) formed in an outer peripheral surface of the stator 4. This allows the bus bar holder 70 to be stably fixed at a position in the circumferential direction with respect to the stator 4.

As described above, the motor 1 includes the bus bar 30 in the present embodiment. The bus bar 30 includes the motor connection member 40 electrically connected to the coil 10 provided in the motor 1, and the terminal member 50 that is formed of a separate member from the motor connection member 40 and is electrically connected to the external terminal 90. The motor connection member 40 includes the body portion 41 electrically connected to the coil 10, and the bent portion 42 that is bent at the first end portion 41a of the body portion 41 in a direction intersecting with the body portion 41. The terminal member 50 is connected to the bent portion 42.

Such structure enables the terminal member 50 to use a member selected each time according to specifications. In contrast, the motor connection member 40 can use an identical common member regardless of specifications. That is, the motor connection member 40 can be standardized and mass-produced. Thus, the connection portion to the external terminal 90 (connection terminal 91) can be flexibly changed in thickness, material, and the like according to specifications, and manufacturing cost can be reduced by sharing members.

The bent portion 42 is provided in the motor connection member 40 that is standardized and mass-produced instead of the terminal member 50 for which thickness, material, and the like are selected each time according to specifications. This enables a bending process of the member to be incorporated in a mass production process of the motor connection member 40, so that the manufacturing cost can be further reduced.

Typically, the terminal member 50, which is a connection portion to the external terminal 90, is often made of a more expensive material than the motor connection member 40. When the bent portion 42 is provided in the motor connection member 40, a dimension L of the terminal member 50 can be reduced accordingly. This enables reducing use of an expensive material and manufacturing cost.

When the bus bar 30 according to the present embodiment is applied to the motor 1, the manufacturing cost of the bus bar 30 is reduced, and thus accordingly manufacturing cost of the entire motor 1 can be reduced.

In the present embodiment, the terminal member 50 and the motor connection member 40 are different in thickness and material. The neutral point member 60 and the motor connection member 40 are identical in thickness and material. The neutral point member 60 and the terminal member 50 are different in thickness and material. That is, the terminal member 50 is different in thickness from the motor connection member 40 and the neutral point member 60. The terminal member 50 is different in material from the motor connection member 40 and the neutral point member 60. For example, a plate material made of tough pitch copper (C1100) and having a thickness of 1.0 mm may be used for each motor connection member 40 and the neutral point member 60. In contrast, a plate material made of a Cu—Fe-based alloy (C19400) and having a thickness of 0.8 mm may be used for the terminal member 50.

According to such structure, the motor connection member 40 and the terminal member 50 are different in thickness, so that the terminal member 50, which is a connection portion to the external terminal 90, can be flexibly changed in thickness according to specifications while the manufacturing cost is reduced by standardizing thickness of the motor connection member 40.

When the motor connection member 40 and the terminal member 50 are each made of a different material, effect as with that described above can be obtained.

The neutral point member 60 and the motor connection member 40 each having an identical thickness enables manufacturing using the same member, so that manufacturing cost can be reduced. Additionally, welded portions of the neutral point member 60 and the motor connection member 40 to the conducting wire 9 (coil 10) are identical in thickness, so that welding workability is improved.

Even when the neutral point member 60 and the motor connection member 40 are made of the same material, effect as with that described above can be obtained.

The combination of thickness and material described above is merely an example, and other combinations may be applied. For example, the terminal member 50 and the motor connection member 40 may be identical in at least one of thickness and material. The neutral point member 60 and the motor connection member 40 may be different in at least one of thickness and material. The neutral point member 60 and the terminal member 50 may be identical in at least one of thickness and material. Members identical in thickness and material may be used for all the members.

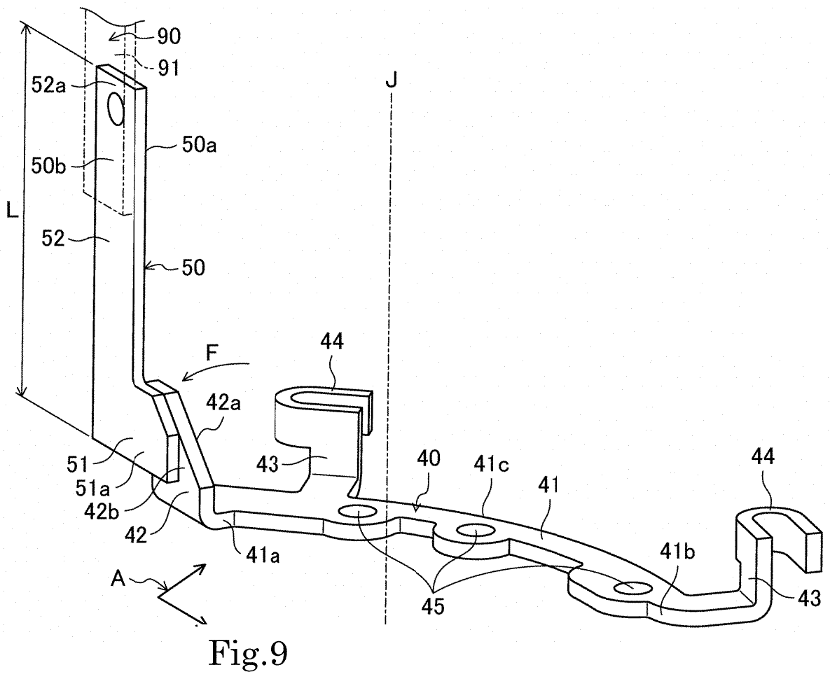

FIG. 9 illustrates each motor connection member 40 and each terminal member 50 according to a modification of the embodiment of the present invention. In the present modification, the end portion 51a of the first extending portion 51 of each terminal member 50 is connected to the second surface 42b of the bent portion 42, being opposite to the first surface 42a facing the body portion 41. The connection terminal 91 of the external terminal 90 is connected to the surface 50b of the end portion 52a of the second extending portion 52, being opposite to the surface 50a facing the body portion 41.

As described above, each motor connection member 40 is formed by bending one plate-like member in a shape in which the bent portion 42 intersects the body portion 41. Thus, a spring back force F allowing the motor connection member 40 to return to an original shape before being bent acts on the motor connection member 40. The spring back force F acts on a direction from a side close to the body portion toward a side far from the body portion 41 with reference to a direction in which the bent portion 42 is bent (a direction in which the bent portion 42 extends). That is, the direction of the spring back force F is counterclockwise from the second end portion 41b to the first end portion 41a as viewed from the one axial side. Then, when the terminal member 50 is connected to the second surface 42b of the bent portion 42 as in the present modification, the terminal member 50 resists the spring back force F allowing the bent portion 42 to return to an original attitude. That is, the bent portion 42 is prevented from returning to the original attitude before being bent. This causes the bent portion 42 to be less likely to be displaced as compared with when each terminal member 50 is connected to the first surface 42a of the bent portion 42 (see FIG. 6). As a result, positional deviation of the end portion 52a of the terminal member 50, which is a welded portion to the external terminal 90 (connection terminal 91), is reduced, so that reliability can be improved.

Although the present invention has been described above with reference to the preferable embodiment, such description is not a limitation, and thus various modifications can be made. In the present embodiment, the bent portion 42 is bent in the direction orthogonal to the extending direction of the body portion 41, but is not limited thereto, and may be bent at an acute angle or an obtuse angle, for example, as long as it is bent in an intersecting direction.

Each motor connection member 40 may be disposed in so-called vertical placement in which the body portion 41 has a width direction coinciding with the axial direction of the motor 1.

Each motor connection member 40 may include a body portion 41 that extends in a linear shape, an L shape, or an S shape, for example, instead of extending in an arc shape.

Each motor connection member 40 may extend in an opposite direction. In this case, the terminal members 50U, 50V, and 50W are dispersedly disposed at a plurality of places.

The motor connection members 40 may be arranged along the plane A instead of being disposed overlapping each other in the axial direction.

Each motor connection member 40 is not limited to a plate-like shape and may have any shape such as a rod-like shape as long as it includes the bent portion 42 bent at the first end portion 41a of the body portion 41 in the direction intersecting with the body portion 41. Similarly, each terminal member 50 and the neutral point member 60 are not limited to a plate-like shape, and may have any shape such as a rod-like shape.

The motor 1 is not limited to a three-phase motor, and may be, for example, a single-phase motor or a multiphase motor.

The structure in the present embodiment and the modification may be appropriately combined as long as they do not contradict each other.

Application of the motor 1 of the present embodiment is not particularly limited, and the motor 1 can be used as, for example, a motor for an automobile, an industrial, or a home appliance. The motor 1 of the present embodiment can be preferably used for an electric vehicle (EV) drive motor, a hybrid electric vehicle (HEV) drive motor, and the like.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A bus bar used for a motor, the bus bar comprising:
a motor connection member that is electrically connected to a coil provided in the motor; and
a terminal member that is formed of a separate member from the motor connection member and is electrically connected to an external terminal,
the motor connection member including:
a body portion electrically connected to the coil; and
a bent portion bent at a first end portion of the body portion in a direction intersecting the body portion, and
the terminal member being connected to the bent portion.

2. The bus bar according to claim 1, wherein
the terminal member includes a first extending portion and a second extending portion that intersect with each other,
the first extending portion has an end portion connected to the bent portion, and
the second extending portion has an end portion connected to the external terminal.

3. The bus bar according to claim 1, wherein
the body portion extends along a plane orthogonal to an axial direction of the motor, and
the bent portion is bent in the axial direction of the motor.

4. The bus bar according to claim 1, wherein
the body portion extends in an arc shape.

5. The bus bar according to claim 1, wherein
the motor connection member is one of a plurality of motor connection members, and
the motor connection members are each disposed with the body portion extending in an identical direction.

6. The bus bar according to claim 1, wherein
the motor connection member is one of the plurality of motor connection members, and
the motor connection members each including the body portion in a plate-like shape are disposed overlapping each other in a thickness direction of the body portion.

7. The bus bar according to claim 1, wherein
the terminal member and the motor connection member are different in thickness.

8. The bus bar according to claim 1, wherein
the terminal member and the motor connection member are different in material.

9. The bus bar according to claim 1, further comprising:
a neutral point member,
wherein the neutral point member is electrically connected to each of a plurality of coils provided in the motor to constitute a neutral point.

10. The bus bar according to claim 9, wherein
the neutral point member and the motor connection member are identical in thickness.

11. The bus bar according to claim 9, wherein
the neutral point member and the motor connection member are identical in material.

12. The bus bar according to claim 1, wherein
the terminal member is connected to a second surface of the bent portion, being opposite to a first surface of the bent portion, facing the body portion.

13. A motor comprising the bus bar according to claim 1.
